(19) United States
(12) Patent Application Publication
(10) Pub. No.: US 2025/0159721 A1
(43) Pub. Date: May 15, 2025

(54) CAPABILITIES FOR MLD BROADCAST TWT OPERATION

(71) Applicant: Samsung Electronics Co., Ltd., Suwon-si (KR)

(72) Inventors: Rubayet Shafin, Allen, TX (US); Boon Loong Ng, Plano, TX (US)

(21) Appl. No.: 18/930,940

(22) Filed: Oct. 29, 2024

Related U.S. Application Data
(60) Provisional application No. 63/548,505, filed on Nov. 14, 2023.

(51) Int. Cl. H04W 74/04

(52) U.S. Cl. CPC H04W 74/04

(57) ABSTRACT

A non-access point multi-link device (non-AP MLD) in a wireless network, the non-AP MLD comprising a memory and a processor configured to: establish a plurality of links, including a first link between a first STA and a first AP and a second link between a second STA and a second AP; transmit, to the first AP on the first link, a request frame to request setup of one or more target wake time (TWT) schedules, wherein the request frame includes link identifier information that indicates the first link and the second link; receive, from the first AP on the first link, a response frame that accepts the request to setup the one or more TWT schedules, wherein the response frame includes the link identifier information that indicates the first link and the second link; and transmit, to the first AP, one or more frames based on a first TWT schedule.

### CROSS-REFERENCE TO RELATED APPLICATION(S)

This application claims the benefit of priority from U.S. Provisional Application No. 63/548,505, entitled “CAPABILITIES FOR MLD-LEVEL FOR BROADCAST TWT OPERATION” filed Nov. 14, 2023, which is incorporated herein by reference in its entirety.

### TECHNICAL FIELD

This disclosure relates generally to a wireless communication system, and more particularly to, for example, but not limited to, capabilities for broadcast target wake time (TWT) operation in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a non-access point (AP) multi-link device (MLD) in a wireless network, the non-AP MLD comprising a memory; and a processor coupled to the memory. The processor is configured to establish a plurality of links, including a first link between a first station (STA) affiliated with the non-AP MLD and a first AP affiliated with an AP MLD, and a second link between a second STA affiliated with the non-AP MLD and a second AP affiliated with the AP MLD. The processor is configured to transmit, to the first AP on the first link, a request frame to request setup of one or more target wake time (TWT) schedules, wherein the request frame includes link identifier information that indicates the first link and the second link. The processor is configured to receive, from the first AP on the first link, a response frame that accepts the request to setup the one or more TWT schedules, wherein the response frame includes the link identifier information that indicates the first link and the second link. The processor is configured to transmit, to the first AP, one or more frames based on a first TWT schedule. The processor is configured to transmit, to the second AP, one or more frames based on a second TWT schedule.

In some embodiments, the request frame comprises a TWT element that includes the link identifier information and one or more TWT parameter sets that apply to the first link and the second link identified in the link identifier information.

In some embodiments, the processor is further configured to transmit, to the first AP on the first link, a frame that indicates that the non-AP MLD supports a broadcast TWT operation including setting up the one or more TWT schedules on multiple links.

In some embodiments, the processor is further configured to receive, from the first AP on the first link, a frame that indicates that the AP MLD supports a broadcast TWT operation including setting up the one or more TWT schedules on multiple links.

In some embodiments, the processor is further configured to determine that the first link and the second link are not disabled or restricted before transmitting, to the first AP on the first link, the request frame.

In some embodiments, the request frame comprises a TWT element that includes one or more TWT parameter sets, and the link identifier information is present in all the TWT parameter sets when an indication in the request frame indicating the presence of the link identifier information.

In some embodiments, the request frame includes the link identifier information that indicates a third link between a third STA affiliated with the non-AP MLD and a third AP affiliated with the AP MLD, wherein the processor is further configured to transmit, to the third AP, one or more frames based on a third TWT schedule.

One aspect of the present disclosure provides an access point (AP) multi-link device (MLD) in a wireless network, the AP MLD comprising: a memory; and a processor coupled to the memory. The processor is configured to establish a plurality of links, including a first link between a first station (STA) affiliated with a non-AP MLD and a first AP affiliated with the AP MLD, and a second link between a second STA affiliated with the non-AP MLD and a second AP affiliated with the AP MLD. The processor is configure to receive, from the first STA on the first link, a request frame to request setup of one or more target wake time (TWT) schedules, wherein the request frame includes link identifier information that indicates the first link and the second link. The processor is configured to transmit, to the first STA on the first link, a response frame that accepts the request to setup the one or more TWT schedules, wherein the response frame includes the link identifier information that indicates the first link and the second link. The processor is configured to transmit, to the first STA, one or more frames based on a first TWT schedule. The processor is configured to transmit, to the second STA, one or more frames based on a second TWT schedule.

In some embodiments, the request frame comprises a TWT element that includes the link identifier information and one or more TWT parameter sets that apply to the first link and the second link identified in the link identifier information.

In some embodiments, the processor is further configured to receive, from the first STA on the first link, a frame that indicates that the non-AP MLD supports a broadcast TWT operation including setting up the one or more TWT schedules on multiple links.

In some embodiments, the processor is further configured to transmit, to the first STA on the first link, a frame that indicates that the AP MLD supports a broadcast TWT operation including setting up the one or more TWT schedules on multiple links.

In some embodiments, the request frame comprises a TWT element that includes one or more TWT parameter sets, and the link identifier information is present in all the TWT parameter sets when an indication in the request frame indicating the presence of the link identifier information.

In some embodiments, request frame includes the link identifier information that indicates a third link between a third STA affiliated with the non-AP MLD and a third AP affiliated with the AP MLD, wherein the processor is further configured to transmit, to the third STA, one or more frames based on a third TWT schedule.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates multi-link discovery and setup in accordance with an embodiment.

FIG. 5A illustrates a basic multi-link element in accordance with an embodiment.

FIG. 5B illustrates an extended MLD Capabilities and Operations subfield format in accordance with an embodiment.

FIG. 6A shows an example of a target wake time (TWT) element in accordance with an embodiment.

FIG. 6B illustrates a broadcast TWT Parameter Set field format in accordance with an embodiment.

FIG. 7 illustrates an additional MIB attribute to a MIB variable in accordance with an embodiment.

FIG. 8 illustrates a process flow for a broadcast TWT for MLD in accordance with an embodiment.

FIG. 9 illustrates a flow chart of an example process by a non-AP MLD for establishing a broadcast TWT in accordance with an embodiment.

FIG. 10 illustrates a flow chart of an example process by an AP MLD for establishing a broadcast TWT in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

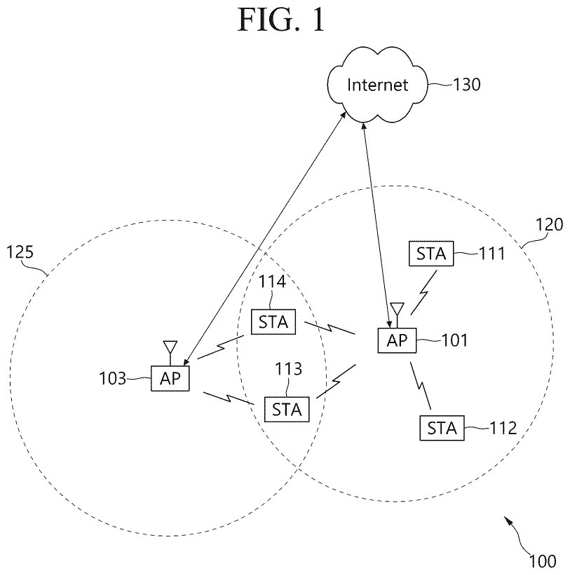

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs.

Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

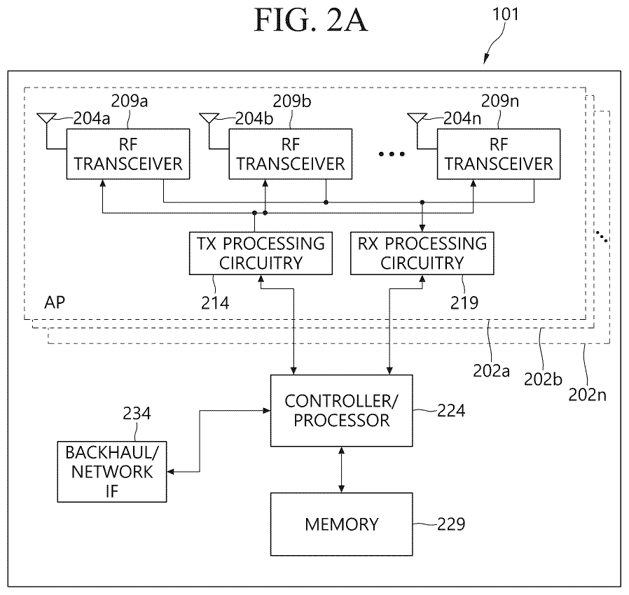

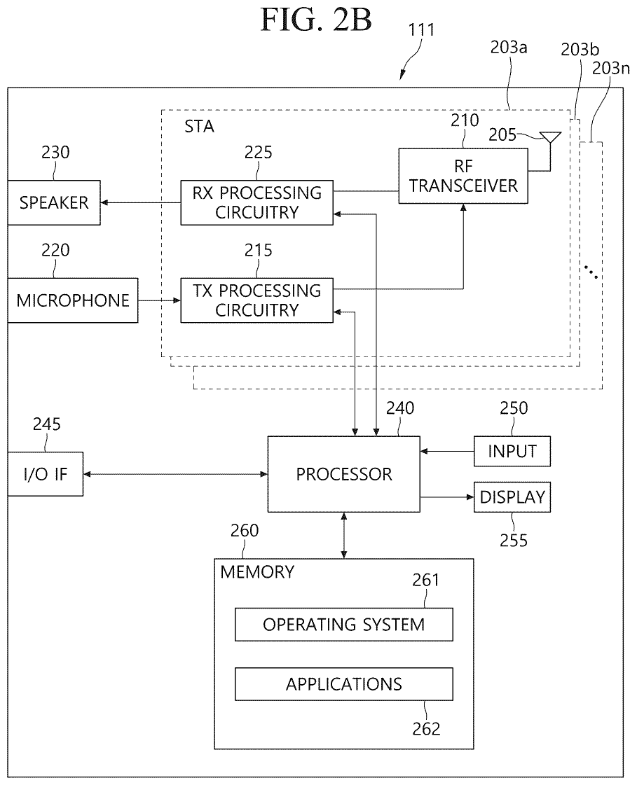

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

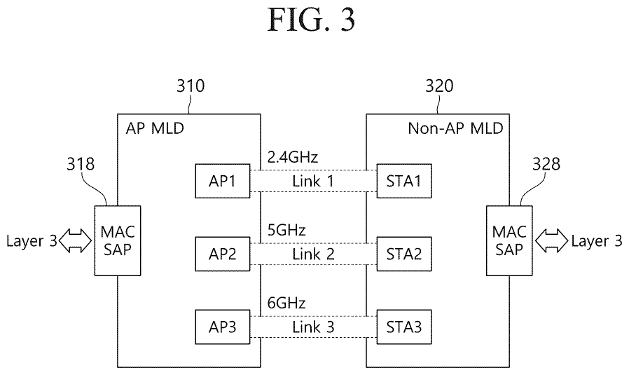

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D3.0, “Wireless LAN Medium Access Control (MAC) and Physical Layer (PHY) Specifications.”

Multi-link operation may allow the discovery and setup of multiple links between an AP MLD and a non-AP MLD, where the discovery or the setup can take place over a single link.

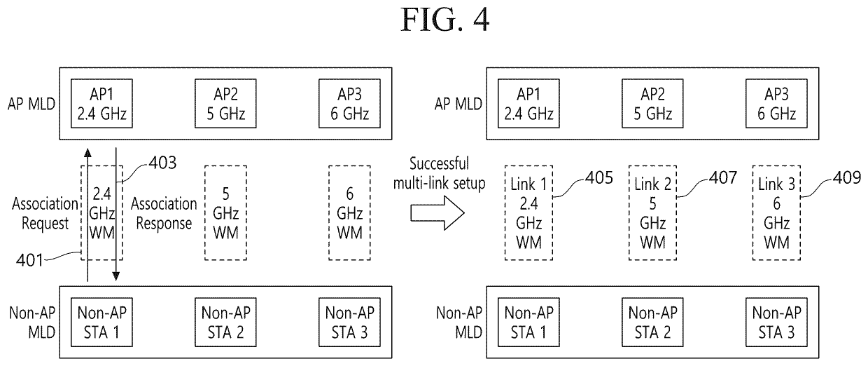

FIG. 4 illustrates multi-link discovery and setup in accordance with an embodiment. In particular, FIG. 4 illustrates an AP MLD communicating with a non-AP MLD. As illustrated, AP MLD is associated with AP1, AP2 and AP3, and non-AP MLD is associated with non-AP STA1, non-AP STA 2, and non-AP STA3. The non-AP MLD transmits an association request frame 401 to AP MLD. AP MLD then transmits an association response frame 403 to non-AP MLD. In FIG. 4, the association request frame 401 and the association response frame takes place over the 2.4 GHz link between the AP MLD and the non-AP MLD, where the setup is for establishing three links between the AP MLD and the non-AP MLD: one link on the 2.4 GHz band, a second link on the 5 GHz band, and a third link on the 6 GHz band. After the successful setup, the three links, including link 1 at 2.5 GHz 405, link 2 at 5 GHz 407, and link 3 at 6 GHz 409, are established between the AP MLD and the non-AP MLD.

Target wake time (TWT) is an important feature for power management in Wi-Fi (wireless fidelity) networks. With TWT operation, it may suffice for a STA to only wake up at pre-scheduled time negotiated with another STA or AP in the network. Two types of TWT operation may be possible, including individual TWT operation and broadcast TWT operation. In individual TWT operations, individual TWT agreements may be established between two STAs or between an STA and an AP. With broadcast TWT operation, an AP can set up a shared TWT session for a group of STAs.

Restricted TWT operation is a feature in the IEEE 802.11be standard, which provides more protection for restricted TWT scheduled STAs in order to serve an STA's latency sensitive application in a timely manner. Restricted TWT may be based on broadcast TWT operations. However, there may be some characteristics that make restricted TWT operation an important feature for supporting low-latency applications in WLAN systems.

Unlike an individual TWT element, a broadcast TWT element can carry multiple broadcast TWT schedules. Each of the broadcast TWT schedules can apply to a different link. Note that this may be different from a particular schedule being applied to multiple links. Using an MLO Link Information element may impose a limitation on this by restricting all the schedules to be applied to only one link only, which may be indicated by a bitmap in the MLO Link Information element. Accordingly, embodiments in accordance with this disclosure may use similar stacks for implementing both the individual TWT and the broadcast TWT.

For individual TWT, a Link ID Bitmap in the individual TWT element may be used for MLO operation. Accordingly, embodiments in accordance with this disclosure may re-use a Link ID Bitmap for a broadcast TWT element. This may be different from using the MLO Link Information element for broadcast TWT and a Link ID Bitmap for individual TWT.

In some embodiments, the Link ID Bitmap may only be present in the broadcast TWT parameter set during an individually-addressed negotiation and may not be present during the advertisement in the Beacon frames and/or Probe Response frames.

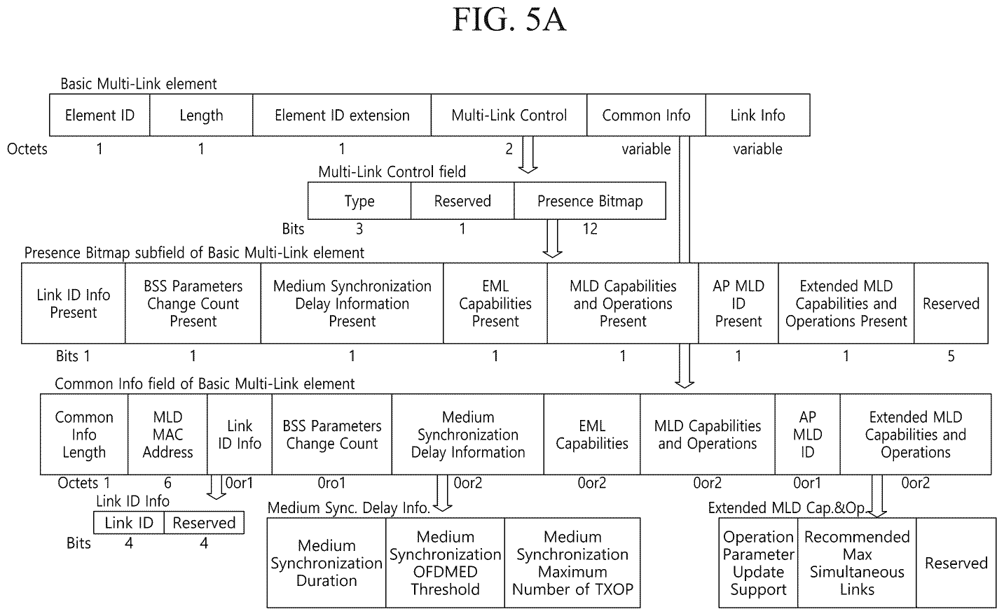

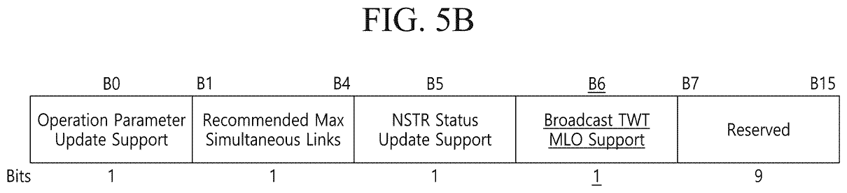

FIG. 5A illustrates a basic multi-link element in accordance with an embodiment. As illustrated, the basic multi-link element may include an element ID field, a length field, an element ID extension field, a multi-link control field, a common info field, and a link info field. The element ID may include an identifier for the element. The length may include length information for the element. The element ID extension may include extension information for the element. The multi-link control field may include link control information, and can include several subfields, including a type field, a reserved field and a presence bitmap field.

The common info field can include common information and can include several subfields including a common info length field, a MLD MAC address field, a link ID info field, a basis service set (BSS) parameters change count present field, a medium synchronization delay information field, an enhanced multi-link (EML) capabilities field, an MLD capabilities and operations field, an AP MLD ID field, and an extended MLD capabilities and operations field.

The link ID info field can include several subfields including a link ID field and a reserved field. The medium synchronization delay information field can include medium synchronization delay information and may include several subfields, including a medium synchronization duration field, a medium synchronization OFDM ED threshold field, and a medium synchronization maximum number of TXOP field. The extended MLD capabilities and operations field can include extended MLD capabilities and operations information and can include several subfields, including an operation parameter update support field, a recommended max simultaneous links field, and a reserved field.

Referring back to the link info field of the basic multi-link element, the link info field can include link information for the element. The type field can include type information for the multi-link control field. The reserved field may be reserved. The presence bitmap field can provide link information within the various subfields. In particular, the presence bitmap field can include a link ID info present field, a basic service set (BSS) parameters change count present field, a medium synchronization delay information present field, an EML capabilities present field, an MLD capabilities and operations present field, an AP MLD ID present field, an extended MLD capabilities and operations present field and a reserved field.

The link ID info present field can provide link ID information. The BSS parameters change count present can provide information regarding BSS parameters. The medium synchronization delay information present field can provide medium synchronization delay information. The EML capabilities present field can provide EML capabilities information. The MLD capabilities and operations present field can provide MLD capabilities and operations information and can include several subfields as described below. The AP MLD ID present field can include AP MLD identifier information. The extended MLD capabilities and operations field can provide MLD capabilities and operations information. The reserved field may be reserved.

The MLD capabilities and operations present field can include the various subfields. In particular, the common info length field can provide length information of the common info field of the basis multi-link element. The MLD MAC address field can provide MAC address information. The link ID info field can provide link ID information and can include a link ID subfield and a reserved subfield. The link ID subfield may provide an identifier information. The reserved field may be reserved. The BSS parameters change count field may provide BSS parameters information. The medium synchronization delay information field may provide delay information and can include a medium synchronization duration field, a medium synchronization OFDM ED threshold field, and a medium synchronization maximum number of TXOP fields. The medium synchronization duration field may provide duration information. The medium synchronization OFDM ED threshold may provide OFDM ED threshold information. The medium synchronization maximum number of TXOP may provide a maximum number of TXOP information.

The EML capabilities field may provide EML capabilities information. The MLD capabilities and operations field may provide MLD capabilities and operations information. The AP MLD ID field may provide an AP MLD identifier information. The extended MLD capabilities and operations field may provide extended MLD capabilities and operations information and can include an operation parameter update support field, a recommended max simultaneous links field and a reserved field. The operation parameter update support field can include operation parameter update support information. The recommended max simultaneous links field may provide a recommended maximum number of enabled links that a non-AP MLD can operate on for simultaneous frame exchanges and the reserved field may be reserved.

FIG. 5B illustrates an extended MLD Capabilities and Operations subfield format in accordance with an embodiment. The MLD Capabilities and Operations subfield may include an operation parameter update support field, a recommended max simultaneous links field, a non-simultaneous transmit and receive (NSTR) status update support field, a broadcast TWT MLO support field, and a reserved field. The operation parameter update support field can include operation parameter update support information. The recommended max simultaneous links field may provide a recommended maximum number of enabled links that a non-AP MLD can operate on for simultaneous frame exchanges. The NSTR status update support field can provide NSTR status update information. The broadcast TWT MLO support field may provide an indication of support for broadcast TWT operation, as set for in Table 1 below. The reserved field may be reserved. The Broadcast TWT MLO support field may indicate support for broadcast TWT operation for a STA affiliated with an MLD by including a Link ID Bitmap subfield in a broadcast TWT parameter set field. In some embodiments, the Broadcast TWT MLO support field may be set to 1 if dot11EHTBroadcastTWTMLOOptionImplemented is true, otherwise it may be set to 0.

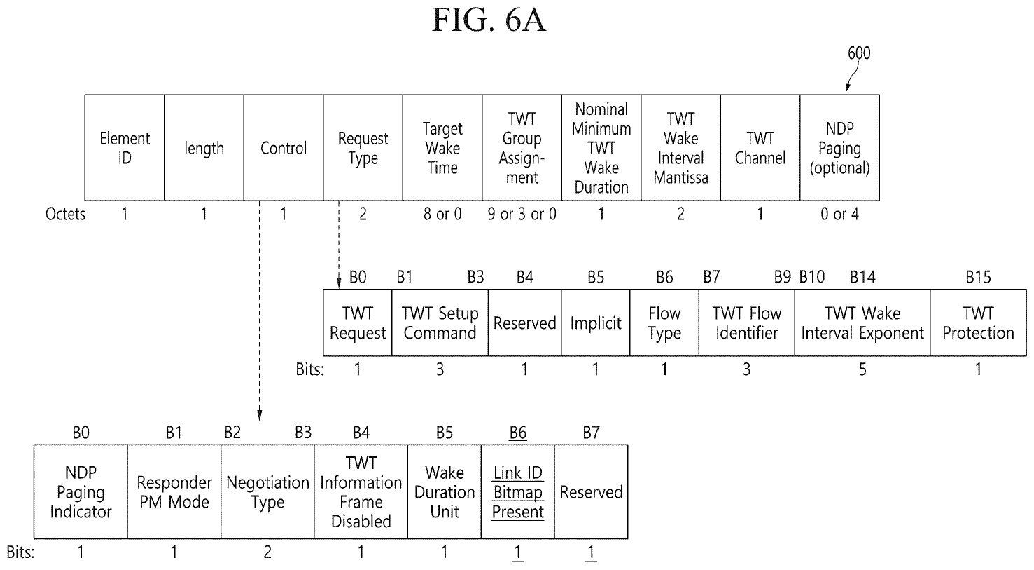

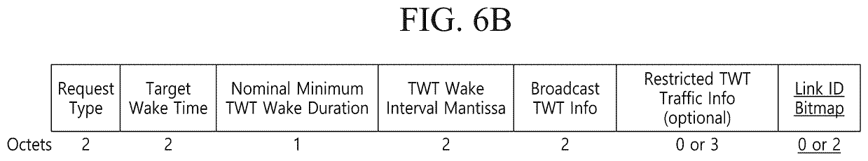

FIG. 6A shows an example of a TWT element 600 in accordance with an embodiment. The TWT element 600 may be applicable to IEEE 802.11be standard and any future amendments to the IEEE standard. The TWT element 600 may be included in a broadcast frame, such as a beacon frame, an association response frame, a reassociation response frame, or a probe response frame, transmitted by APs affiliated with the AP MLD.

Details about each field and subfields of the TWT element 1000 are further explained below. In FIG. 6A, the TWT element 1000 may include an Element identifier (ID) field, a length field, a Control field, a Request Type filed, a Target Wake Time field, a TWT Group Assignment field, a Nominal Minimum TWT Wake Duration field, a TWT Wake Interval Mantissa field, a TWT Channel field, and a NPD Paging (optional) field.

The Element ID field may include information to identify the TWT element 1000. The Length field may indicate a length of the TWT element 1000.

The Control field may include a null data PPDU (physical layer protocol data unit) (NDP) Paging Indicator subfield, a Responder power management (PM) Mode subfield, a Negotiation Type subfield, a TWT Information Frame Disabled subfield, a Wake Duration Unit subfield, a Link ID Bitmap Present subfield, and a Reserved subfield. The NDP Paging Indicator subfield may indicate whether an NDP paging field is present or not in an Individual TWT Parameter Set field. The Responder PM Mode subfield may indicate the power management mode, such as active mode and power save (PS) mode. The Negotiation Type subfield may indicate whether the information included in the TWT element is for the negotiation of parameters of broadcast or individual TWT or Wake TBTT (target beacon transmission time) interval. The MSB (most significant bit) of the Negotiation Type subfield is the Broadcast field which indicates if one or more Broadcast TWT Parameter Sets are contained in the TWT element. The TWT Information Frame Disabled subfield may indicate whether the reception of TWT information frame is disabled by the STA. The Wake Duration Unit subfield may indicate the unit of the Nominal Minimum TWT Wake Duration subfield in the TWT element 1000. The Link ID Bitmap Present subfield may indicate the presence of the Link ID Bitmap field in the TWT element. The TWT Parameter Information field of the TWT element 1000 may include either a single Individual TWT Parameter Set field or one or more Broadcast TWT Parameter Set fields 1020. In some implementations, if the Broadcast subfield of the Negotiation Type subfield in the Control field is 0, the TWT Parameter Information field includes the single Individual TWT Parameter Set field. Otherwise, the TWT Parameter Information field includes one or more Broadcast TWT Parameter Set fields.

The Request Type field will be explained in further detail below.

The Target Wake Time field may indicate the start time of the TWT service period (SP) on the corresponding link.

The Nominal Minimum TWT Wake Duration field may indicate the minimum amount of time that the TWT scheduled STA is expected to be awake in order to compete the frame exchanges for the period of TWT wake interval.

The TWT Wake Interval Mantissa field may indicate the value of the mantissa of the TWT wake interval value.

The TWT Channel field may provide channel information for the TWT.

The NPD Paging (optional) field may provide NPD paging information.

The Request Type field may include a TWT Request subfield, a TWT Setup Command subfield, a reserved subfield, an Implicit subfield, a Flow Type subfield, a TWT Flow Identifier subfield, a TWT Wake Interval Exponent subfield, and a TWT Protection subfield.

The TWT Request subfield may indicate if the transmitting STA is a TWT scheduling AP (or STA) or a TWT scheduled STA (or AP). The TWT Setup Command subfield may indicate the type of TWT command such as Request TWT, Suggest TWT, Demand TWT, TWT Grouping, Accept TWT, Alternate TWT, Dictate TWT and Reject TWT. The Reserved subfield may be a reserved field. The Implicit subfield may be used for an implicit TWT agreement. The Flow Type subfield may indicate the type of interaction, for example, an announced TWT or an unannounced TWT between the TWT scheduled STA and the TWT scheduling AP at TWT. The TWT Flow Identifier subfield may be used to provide a TWT flow identifier. The TWT Wake Interval Exponent may indicate the value of the exponent of the TWT wake interval value. The TWT Protection subfield may be used to protect the TWT element.

FIG. 6B illustrates a broadcast TWT Parameter Set field format in accordance with an embodiment. The broadcast TWT Parameter Set field can include a request type field, a target wake time field, a nominal minimum TWT wake duration field, a TWT wake interval Mantissa field, a Broadcast TWT info field, a restricted TWT traffic info (optional) field, and a link ID bitmap field. The Request Type field may indicate a type of request. The target wake time field may indicate the start time of the TWT service period (SP) on the corresponding link. The nominal minimum TWT wake duration field may indicate the minimum amount of time that the TWT scheduled STA is expected to be awake in order to compete the frame exchanges for the period of TWT wake interval. The TWT wake interval mantissa field may indicate the value of the mantissa of the TWT wake interval value. The broadcast TWT info field may include broadcast TWT information. The restricted TWT info field (optional) may include restricted TWT information.

The Link ID Bitmap subfield may indicate the links to which an individual or broadcast TWT parameter set included in the TWT element sent by a STA affiliated with an MLD applies. In some embodiments, a value of 1 in bit position i of the Link ID Bitmap subfield may indicate that the TWT parameter set in the TWT element sent by a STA affiliated with an MLD applies to the link identified by link ID i. A value of 0 in bit position i of the Link ID Bitmap subfield may indicate that the TWT parameter set in the TWT element sent by a STA affiliated with an MLD does not apply to the link identified by link ID i.

In some embodiments, in a broadcast TWT element, if the Link ID Bitmap Present field is set to 1, then the Link ID Bitmap field may be present in all the broadcast TWT parameter sets in the broadcast TWT element. Otherwise, if the Link ID Bitmap Present field is set to 0, the Link ID Bitmap field may not be present in any of the broadcast TWT parameter set. In some embodiments, in a broadcast TWT parameter set in a broadcast TWT element, the Link ID Bitmap field is not present if the Negotiation Type subfield in the Control field of the broadcast TWT element is set to 2.

In some embodiments, an MLD with dot11EHTBroadcastTWTMLOOptionImplemented equal to true shall set the Broadcast TWT MLO Support subfield of the Extended MLD Capabilities and Operations subfield of the Common Info field of a Basic Multi-Link element to 1. In some embodiments, a TWT scheduling AP affiliated with an AP MLD shall not send a broadcast TWT element with the Link ID Bitmap Present subfield of the Control field of the broadcast TWT element set to 1 to a STA affiliated with a non-AP MLD if the AP MLD has not received a Basic Multi-Link element from the non-AP MLD with the Broadcast TWT MLO Support subfield of the Extended MLD Capabilities and Operations subfield of the Common Info field of the Basic Multi-Link element set to 1.

In some embodiments, a TWT scheduled STA affiliated with a non-AP MLD shall not send a broadcast TWT element with the Link ID Bitmap Present subfield of the Control field of the broadcast TWT element set to 1 to an AP affiliated with an AP MLD if the non-AP MLD has not received a Basic Multi-Link element from the AP MLD with the Broadcast TWT MLO Support subfield of the Extended MLD Capabilities and Operations subfield of the Common Info field of the Basic Multi-Link element set to 1.

In some embodiments, a TWT scheduled STA affiliated with the non-AP MLD or the TWT scheduling AP affiliated with the AP MLD, while negotiating for a broadcast TWT schedule, may indicate the link between the AP MLD and the non-AP MLD for which the negotiation is being conducted. The TWT scheduled STA or the TWT scheduling AP transmitting the TWT element may make the link indication in the Link ID Bitmap subfield in the Broadcast TWT Parameter Set field corresponding to the broadcast TWT schedule.

In some embodiments, if a link is indicated in a Link ID Bitmap subfield in the Broadcast TWT Parameter Set field transmitted by a TWT scheduled STA affiliated with the non-AP MLD or a TWT scheduling AP affiliated with the AP MLD, the corresponding broadcast TWT schedule may be negotiated on behalf of the STA affiliated with the same MLD and operating on the indicated link between the AP MLD and the non-AP MLD. The value of the Target Wake Time field in the Broadcast TWT Parameter Set field shall be in reference to the time synchronization function (TSF) time of the link indicated in the Link ID Bitmap subfield in the Broadcast TWT Parameter Set field.

In some embodiments, a TWT scheduling AP affiliated with the AP MLD or a TWT scheduled STA affiliated with the non-AP MLD that receives a broadcast TWT parameter set that includes a Link ID Bitmap subfield may indicate the link in the Link ID Bitmap subfield of the corresponding Broadcast TWT Parameter Set field in the TWT element in the response frame it transmits. The Link ID Bitmap subfield, if present in the Broadcast TWT Parameter Set field in the response frame, may indicate the same link as that indicated in the corresponding Broadcast TWT Parameter Set field in the TWT element it received.

In some embodiments, if the Link ID Bitmap Present subfield in the Control field in a broadcast TWT element is set to 1, then all the Broadcast TWT Parameter Set fields included in the broadcast TWT element shall include a Link ID Bitmap subfield; otherwise, none of the Broadcast TWT Parameter Set field included in the broadcast TWT element shall include any Link ID Bitmap subfield.

In some embodiments, if a TWT scheduling AP affiliated with an AP MLD or a TWT scheduled STA affiliated with a non-AP MLD receives a broadcast TWT element that sets the Link ID Bitmap Present subfield to 0, it may indicate that all the broadcast TWT parameter set(s) included in the received broadcast TWT element apply to the link on which the broadcast TWT element is received.

In some embodiments, the AP MLD or the non-AP MLD may not transmit a TWT element over a link set up between them that includes a TWT parameter set field that includes a Link ID Bitmap subfield with k-th bit in the bitmap set to 1 if the corresponding k-th link is disabled for the non-AP MLD through TID-to-Link mapping.

For R-TWT operation between an AP MLD and a non-AP MLD, the AP MLD or the non-AP MLD may not transmit a TWT element over any of the setup links between them that includes an R-TWT parameter set with the k-th bit in the Restricted TWT DL TID Bitmap subfield or Restricted TWT UL TID Bitmap subfield, if present, set to 1 if the TID k for the respective direction is not mapped on the intended link for which the restricted TWT schedule is being negotiated or if the STA affiliated with the non-AP MLD and operating on the intended link does not set the Restricted TWT Support subfield in its transmitted EHT Capabilities element to 1.

In some embodiments, if a TWT scheduling AP affiliated with an AP MLD successfully negotiates membership with a TWT scheduled STA affiliated with a non-AP MLD for a new broadcast TWT schedule which was previously not advertised by the AP in its BSS, and the membership negotiation is conducted by exchanging the corresponding TWT element(s) with another AP affiliated with the same AP MLD that the TWT scheduling AP is affiliated with, then the TWT scheduling AP shall start advertising the new broadcast TWT schedule as soon as practical.

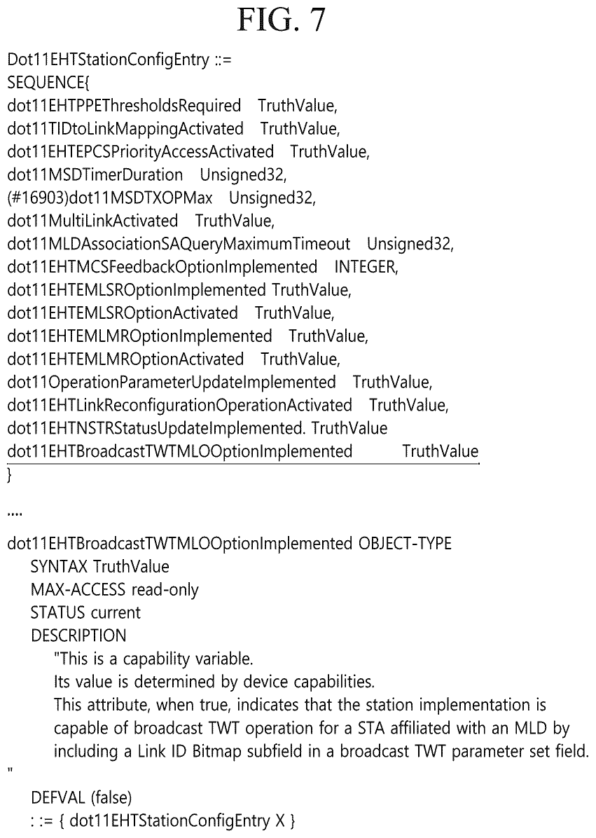

In some embodiments, a new MIB variable dot11EHTBroadcastTWTMLOOptionImplemented can be added as illustrated in FIG. 7 in accordance with an embodiment. In particular, FIG. 7 illustrates the additional of a new attribute: dot11EHTBroadcastTWTMLOOptionImplemented Truth Value to a variable. As indicates, this may be a capability variable whose value may be determined by device capabilities. This attribute, when true, indicates that the station implementation is capable of broadcast TWT operation for a STA affiliated with an MLD by including a Link ID Bitmap subfield in a broadcast TWT parameter set field.

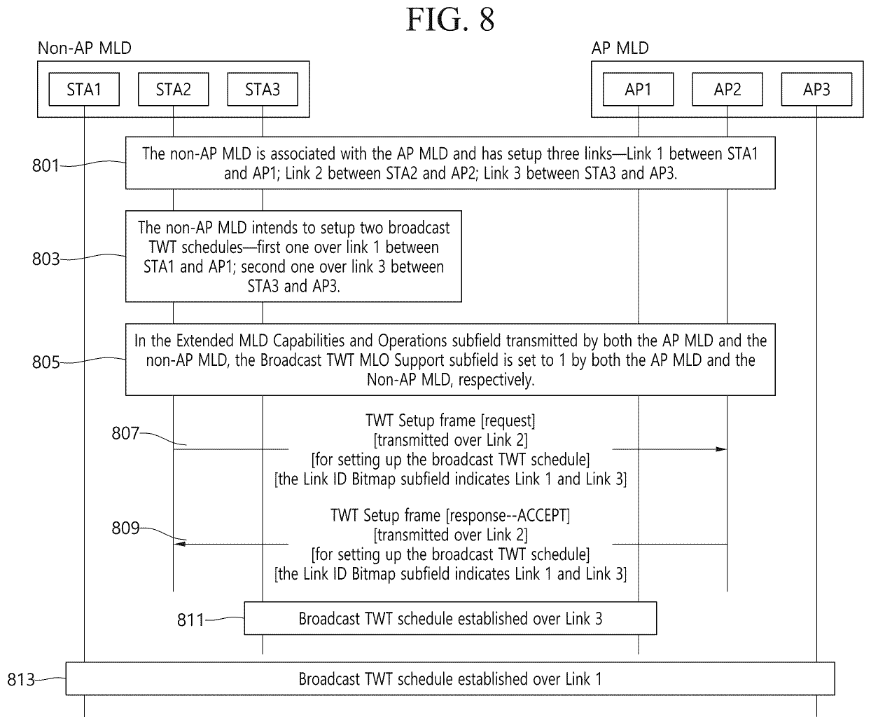

FIG. 8 illustrates a possible process flow for the broadcast TWT for MLD in accordance with an embodiment. Although one or more operations are described or shown in particular sequential order, in other embodiments the operations may be rearranged in a different order, which may include performance of multiple operations in at least partially overlapping time periods. As illustrated, non-AP MLD communicates with AP MLD. STA1, STA2 and STA3 are affiliated with non-AP MLD. AP1, AP2 and AP3 are affiliated with AP MLD.

In operation 801, the non-AP MLD is associated with the AP MLD and has setup three links. In particular, link 1 between STA1 and AP1, link 2 between STA2 and AP2, and link 3 between STA3 and AP3.

In operation 803, the non-AP MLD intends to setup two broadcast TWT schedules, the first one over link 1 between STA1 and AP1, the second one over link 3 between STA3 and AP3.

In operation 805, in the extended MLO Capabilities and Operations subfield transmitted by both the AP MLD and the non-AP MLD, the Broadcast TWT MLO Support subfield is set to 1 by both the AP MLD and the non-AP MLD, respectively, to indicate support for broadcast TWT MLO.

In operation 807, a TWT Setup request frame is transmitted over link 2 from STA2 to AP2. The TWT Setup request frame is for setting up the broadcast TWT schedule and the Link ID Bitmap subfield indicates link 1 and link 3. In some embodiments, the non-AP MLD transmits a TWT setup request frame for setting up the broadcast TWT schedule with a link ID bitmap indicating the one or more links (e.g., link 1 and link 3). In some embodiments, the frame may include a TWT element that includes a Broadcast TWT Parameter Set field that includes a Link ID Bitmap field. The Link ID Bitmap field may indicate the links to which an individual or broadcast TWT parameter set included in a TWT element applies. In some embodiments, a value of 1 in bit position i of the Link ID Bitmap field indicates that the TWT parameter set in the TWT element applies to the link identified by link ID i. A value of 0 in bit position i of the Link ID Bitmap field indicates that the TWT parameter set in the TWT element does not apply to the link identified by link ID i.

In operation 809, a TWT Setup response frame is transmitted over link 2 from AP2 to STA2. The TWT Setup response frame is for setting up the broadcast TWT schedule and the Link ID Bitmap subfield indicates link 1 and link 3. The TWT Setup response frame indicates “Accept”. In some embodiments, the non-AP MLD receives a TWT setup response frame that accepts settings up the broadcast TWT schedule with a link ID bitmap indicating the one or more links (e.g., link 1 and link 3). In some embodiments, the TWT setup response frame may include a TWT element that includes a Broadcast TWT Parameter Set field that includes a Link ID Bitmap. The Link ID Bitmap may indicate the same link as that indicated in the corresponding Broadcast TWT Parameter Set field in the TWT element transmitted in the TWT setup request frame

In operation 811, a broadcast TWT schedule is established over link 3.

In operation 813, a broadcast TWT schedule is established over link 1.

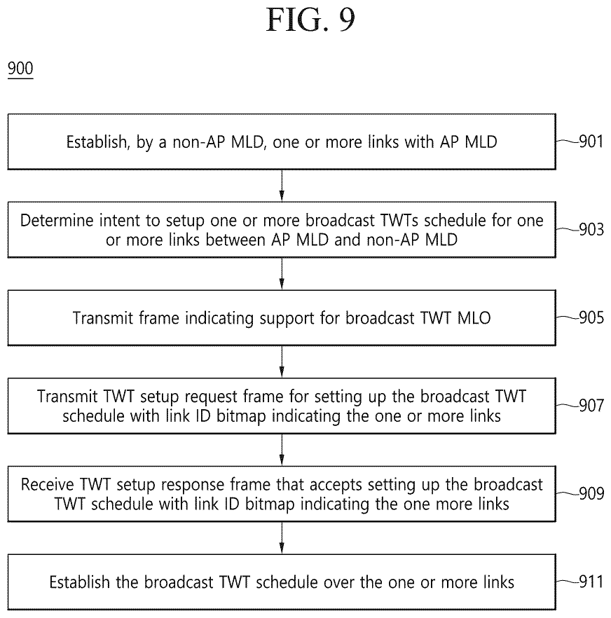

FIG. 9 illustrates a flow chart of an example process by a non-AP MLD for establishing a broadcast TWT in accordance with an embodiment. Although one or more operations are described or shown in particular sequential order, in other embodiments the operations may be rearranged in a different order, which may include performance of multiple operations in at least partially overlapping time periods. The flowchart depicted in FIG. 9 illustrates operations performed in a non-AP MLD, such as non-AP MLD illustrated in FIG. 3. The process 900 begins in operation 901.

In operation 901, the non-AP MLD established one or more links with an AP MLD. In some embodiments, the links may be established between an AP affiliated with the AP MLD and a STA affiliated with the non-AP MLD.

In operation 903, the non-AP MLD determines an intent to setup one or more broadcast TWT schedules for one or more links between the AP MLD and the non-AP MLD.

In operation 905, the non-AP MLD transmits a frame indicating support for broadcast TWT MLO. In some embodiments, an Extended MLD Capabilities and Operation subfield may be used that includes a Broadcast TWT MLO Support field that indicates support for broadcast TWT operation.

In operation 907, the non-AP MLD transmits a TWT setup request frame for setting up the broadcast TWT schedule with a link ID bitmap indicating the one or more links. In some embodiments, the frame may include a TWT element that includes a Broadcast TWT Parameter Set field that includes a Link ID Bitmap field. The Link ID Bitmap field may indicate the links to which an individual or broadcast TWT parameter set included in a TWT element applies. In some embodiments, a value of 1 in bit position i of the Link ID Bitmap field indicates that the TWT parameter set in the TWT element applies to the link identified by link ID i. A value of 0 in bit position i of the Link ID Bitmap field indicates that the TWT parameter set in the TWT element does not apply to the link identified by link ID i.

In operation 909, the non-AP MLD receives a TWT setup response frame that accepts settings up the broadcast TWT schedule with a link ID bitmap indicating the one or more links. In some embodiments, the TWT setup response frame may include a TWT element that includes a Broadcast TWT Parameter Set field that includes a Link ID Bitmap. The Link ID Bitmap may indicate the same link as that indicated in the corresponding Broadcast TWT Parameter Set field in the TWT element transmitted in the TWT setup request frame.

In operation 911, the non-AP MLD establishes the broadcast TWT schedule over the one or more links.

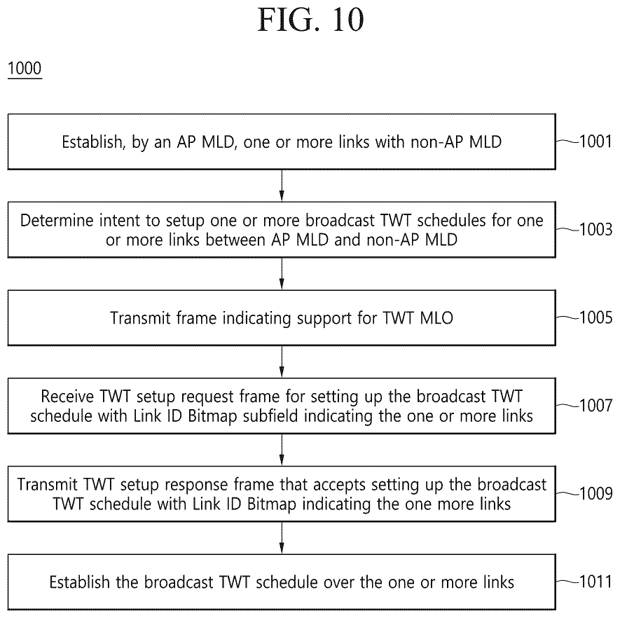

FIG. 10 illustrates a flow chart of an example process by an AP MLD for establishing a broadcast TWT in accordance with an embodiment. Although one or more operations are described or shown in particular sequential order, in other embodiments the operations may be rearranged in a different order, which may include performance of multiple operations in at least partially overlapping time periods. The flowchart depicted in FIG. 10 illustrates operations performed in an AP MLD, such as AP MLD illustrated in FIG. 3. The process 1000 begins in operation 1001.

In operation 1001, the AP MLD established one or more links with a non-AP MLD. In some embodiments, the links may be established between an AP affiliated with the AP MLD and a STA affiliated with the non-AP MLD.

In operation 1003, the AP MLD determines an intent to setup one or more broadcast TWT schedules for one or more links between the AP MLD and the non-AP MLD.

In operation 1005, the AP MLD transmits a frame indicating support for broadcast TWT MLO. In some embodiments, an Extended MLD Capabilities and Operation subfield may be used that includes a Broadcast TWT MLO Support field that indicates support for broadcast TWT operation.

In operation 1007, the AP MLD receives a TWT setup request frame for setting up the broadcast TWT schedule with a link ID bitmap indicating the one or more links. In some embodiments, the frame may include a TWT element that includes a Broadcast TWT Parameter Set field that includes a Link ID Bitmap field. The Link ID Bitmap field may indicate the links to which an individual or broadcast TWT parameter set included in a TWT element applies. In some embodiments, a value of 1 in bit position i of the Link ID Bitmap field indicates that the TWT parameter set in the TWT element applies to the link identified by link ID i. A value of 0 in bit position i of the Link ID Bitmap field indicates that the TWT parameter set in the TWT element does not apply to the link identified by link ID i.

In operation 1009, the AP MLD transmits a TWT setup response frame that accepts settings up the broadcast TWT schedule with a link ID bitmap indicating the one or more links. In some embodiments, the TWT setup response frame may include a TWT element that includes a Broadcast TWT Parameter Set field that includes a Link ID Bitmap. The Link ID Bitmap may indicate the same links as that indicated in the corresponding Broadcast TWT Parameter Set field in the TWT element transmitted in the TWT setup request frame.

In operation 1011, the AP MLD establishes the broadcast TWT schedule over the one or more links.

Embodiments in accordance with this disclosure may allow for using a Link ID bitmap that can indicate several links to which a TWT parameter set applies, which can improve performance of a wireless network by allowing for the configuration of multiple links using a TWT element, rather than requiring the configuration of individual links separately.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A non-access point (AP) multi-link device (MLD) in a wireless network, the non-AP MLD comprising:
a memory; and
a processor coupled to the memory, the processor configured to:
establish a plurality of links, including a first link between a first station (STA) affiliated with the non-AP MLD and a first AP affiliated with an AP MLD, and a second link between a second STA affiliated with the non-AP MLD and a second AP affiliated with the AP MLD;
transmit, to the first AP on the first link, a request frame to request setup of one or more target wake time (TWT) schedules, wherein the request frame includes link identifier information that indicates the first link and the second link;
receive, from the first AP on the first link, a response frame that accepts the request to setup the one or more TWT schedules, wherein the response frame includes the link identifier information that indicates the first link and the second link;
transmit, to the first AP, one or more frames based on a first TWT schedule; and
transmit, to the second AP, one or more frames based on a second TWT schedule.

2. The non-AP MLD of claim 1, wherein the request frame comprises a TWT element that includes the link identifier information and one or more TWT parameter sets that apply to the first link and the second link identified in the link identifier information.

3. The non-AP MLD of claim 1, wherein the processor is further configured to transmit, to the first AP on the first link, a frame that indicates that the non-AP MLD supports a broadcast TWT operation including setting up the one or more TWT schedules on multiple links.

4. The non-AP MLD of claim 1, wherein the processor is further configured to receive, from the first AP on the first link, a frame that indicates that the AP MLD supports a broadcast TWT operation including setting up the one or more TWT schedules on multiple links.

5. The non-AP MLD of claim 1, wherein the processor is further configured to determine that the first link and the second link are not disabled or restricted before transmitting, to the first AP on the first link, the request frame.

6. The non-AP MLD of claim 1, wherein the request frame comprises a TWT element that includes one or more TWT parameter sets, and the link identifier information is present in all the TWT parameter sets when an indication in the request frame indicating the presence of the link identifier information.

7. The non-AP MLD of claim 1, wherein the request frame includes the link identifier information that indicates a third link between a third STA affiliated with the non-AP MLD and a third AP affiliated with the AP MLD, wherein the processor is further configured to transmit, to the third AP, one or more frames based on a third TWT schedule.

8. An access point (AP) multi-link device (MLD) in a wireless network, the AP MLD comprising:
a memory; and
a processor coupled to the memory, the processor configured to:
establish a plurality of links, including a first link between a first station (STA) affiliated with a non-AP MLD and a first AP affiliated with the AP MLD, and a second link between a second STA affiliated with the non-AP MLD and a second AP affiliated with the AP MLD;
receive, from the first STA on the first link, a request frame to request setup of one or more target wake time (TWT) schedules, wherein the request frame includes link identifier information that indicates the first link and the second link;
transmit, to the first STA on the first link, a response frame that accepts the request to setup the one or more TWT schedules, wherein the response frame includes the link identifier information that indicates the first link and the second link;
transmit, to the first STA, one or more frames based on a first TWT schedule; and
transmit, to the second STA, one or more frames based on a second TWT schedule.

9. The AP MLD of claim 8, wherein the request frame comprises a TWT element that includes the link identifier information and one or more TWT parameter sets that apply to the first link and the second link identified in the link identifier information.

10. The AP MLD of claim 8, wherein the processor is further configured to receive, from the first STA on the first link, a frame that indicates that the non-AP MLD supports a broadcast TWT operation including setting up the one or more TWT schedules on multiple links.

11. The AP MLD of claim 8, wherein the processor is further configured to transmit, to the first STA on the first link, a frame that indicates that the AP MLD supports a broadcast TWT operation including setting up the one or more TWT schedules on multiple links.

12. The AP MLD of claim 8, wherein the request frame comprises a TWT element that includes one or more TWT parameter sets, and the link identifier information is present in all the TWT parameter sets when an indication in the request frame indicating the presence of the link identifier information.

13. The AP MLD of claim 1, wherein the request frame includes the link identifier information that indicates a third link between a third STA affiliated with the non-AP MLD and a third AP affiliated with the AP MLD, wherein the processor is further configured to transmit, to the third STA, one or more frames based on a third TWT schedule.

14. A computer-implemented method for communication by an access point (AP) multi-link device (MLD) in a wireless network, comprising:
establishing a plurality of links, including a first link between a first station (STA) affiliated with the non-AP MLD and a first AP affiliated with an AP MLD, and a second link between a second STA affiliated with the non-AP MLD and a second AP affiliated with the AP MLD;
transmitting, to the first AP on the first link, a request frame to request setup of one or more target wake time (TWT) schedules, wherein the request frame includes link identifier information that indicates the first link and the second link;
receiving, from the first AP on the first link, a response frame that accepts the request to setup the one or more TWT schedules, wherein the response frame includes the link identifier information that indicates the first link and the second link;
transmitting, to the first AP, one or more frames based on a first TWT schedule; and
transmitting, to the second AP, one or more frames based on a second TWT schedule.

15. The computer-implemented method of claim 14, wherein the request frame comprises a TWT element that includes the link identifier information and one or more TWT parameter sets that apply to the first link and the second link identified in the link identifier information.

16. The computer-implemented method of claim 14, further comprising transmitting, to the first AP on the first link, a frame that indicates that the non-AP MLD supports a broadcast TWT operation including setting up the one or more TWT schedules on multiple links.

17. The computer-implemented method of claim 14, further comprising receiving, from the first AP on the first link, a frame that indicates that the AP MLD supports a broadcast TWT operation including setting up the one or more TWT schedules on multiple links.

18. The computer-implemented method of claim 14, further comprising determining that the first link and the second link are not disabled or restricted before transmitting, to the first AP on the first link, the request frame.

19. The computer-implemented method of claim 14, wherein the request frame comprises a TWT element that includes one or more TWT parameter sets, and the link identifier information is present in all the TWT parameter sets when an indication in the request frame indicating the presence of the link identifier information.

20. The computer-implemented method of claim 14, wherein the request frame includes the link identifier information that indicates a third link between a third STA affiliated with the non-AP MLD and a third AP affiliated with the AP MLD, wherein the processor is further configured to transmit, to the third AP, one or more frames based on a third TWT schedule.
